(19) United States
(12) Patent Application Publication
(10) Pub. No.: US 2015/0310877 A1
(43) Pub. Date: Oct. 29, 2015

(54) CONVERSATION ANALYSIS DEVICE AND CONVERSATION ANALYSIS METHOD

(71) Applicants: Yoshifumi ONISHI, Minato-ku, Tokyo (JP); Makoto TERAO, Minato-ku, Tokyo (JP); Masahiro TANI, Minato-ku, Tokyo (JP); Koji OKABE, Minato-ku, Tokyo (JP); NEC Corporation, Minato-ku, Tokyo (JP)

(72) Inventors: Yoshifumi ONISHI, Tokyo (JP); Makoto TERAO, Tokyo (JP); Masahiro TANI, Tokyo (JP); Koji OKABE, Tokyo (JP)

(73) Assignee: NEC Corporation, Minato-ku, Tokyo (JP)

(21) Appl. No.: 14/438,953

(22) PCT Filed: Aug. 21, 2013
(86) PCT No.: PCT/JP2013/072243

§ 371 Date: Apr. 28, 2015

(30) Foreign Application Priority Data
Oct. 31, 2012 (JP) 2012-240763

(51) Int. Cl. G10L 25/48; G10L 17/00

(52) U.S. Cl. CPC G10L 25/48; G10L 17/00

(57) ABSTRACT

This conversation analysis device comprises: a change detection unit that detects, for each of a plurality of conversation participants, each of a plurality of prescribed change patterns for emotional states, on the basis of data corresponding to voices in a target conversation; an identification unit that identifies, from among the plurality of prescribed change patterns detected by the change detection unit, a beginning combination and an ending combination, which are prescribed combinations of the prescribed change patterns that satisfy prescribed position conditions between the plurality of conversation participants; and an interval determination unit that determines specific emotional intervals, which have a start time and an end time and represent specific emotions of the conversation participants of the target conversation, by determining a start time and an end time on the basis of each time position in the target conversation pertaining to the starting combination and ending combination identified by the identification unit.

### TECHNICAL FIELD

The present invention relates to a conversation analysis technique.

### BACKGROUND ART

Techniques of analyzing conversations thus far developed include a technique for analyzing phone conversation data. Such a technique can be applied, for example, to the analysis of phone conversation data in a section called call center or contact center. Hereinafter, the section specialized in dealing with phone calls from customers made for inquiries, complaints, and orders about merchandise or service will be referred to as contact center.

In many cases the voice of the customers directed to the contact center reflect the customers' needs and satisfaction level. Therefore, it is essential for the company to extract the emotion and needs of the customer from the phone conversations with the customers, in order to increase the number of repeating customers. The phone conversations from which it is desirable to extract the emotion and other factors of the speaker are not limited to those exchanged in the contact center.

Patent Literature (PTL) 1 cited below proposes a method including measuring an initial value of voice volume for a predetermined time in the initial part of the phone conversation data and the voice volume during the period after the predetermined time to the end of the conversation, calculating a largest change in voice volume with respect to the initial value of the voice volume and setting a customer satisfaction (CS) level on the basis of the change ratio with respect to the initial value, and updating the CS level when a specific keyword is included in keywords extracted from the phone conversation by a voice recognition method. PTL 2 proposes a method including extracting, from voice signals by voice analysis, the peak value, standard deviation, range, average, and inclination of the basic frequency, the average of bandwidth of a first formant and a second formant, and speech rate, and estimating the emotion accompanying the voice signals on the basis of the extracted data. PTL 3 proposes a method including extracting a predetermined number of pairs of utterances between a first speaker and a second speaker as segments, calculating an amount of dialogue-level features (e.g., duration of utterance, number of times of chiming in) associated with the utterance situation with respect to each pair of utterances, obtaining a feature vector by summing the amount of dialogue-level features with respect to each segment, calculating a claim score on the basis of the feature vector with respect to each segment, and identifying the segment given the claim score higher than a predetermined threshold as claim segment.

### CITATION LIST

### Patent Literature

PTL 1: Japanese Unexamined Patent Application Publication No. 2005-252845

PTL 2: Japanese Translation of PCT International Application Publication No. JP-T-2003-508805

PTL 3: Japanese Unexamined Patent Application Publication No. 2010-175684

### SUMMARY OF INVENTION

### Technical Problem

By the foregoing methods, however, the section in which the specific emotion of the speaker is expressed is unable to be accurately acquired from the conversation (phone call). To be more detailed, by the method according to PTL 1 the CS level of the conversation as a whole is estimated. The goal of the method according to PTL 3 is deciding whether the conversation is a claim call as a whole, for which purpose a predetermined number of utterance pairs are picked up for the decision. Therefore, such methods are unsuitable for improving the accuracy in acquiring a local section in which the specific emotion of the speaker is expressed.

The method according to PTL 2 may enable the specific emotion of the speaker to be estimated at some local sections, however the method is still vulnerable when singular events of the speaker are involved. Therefore, the estimation accuracy may be degraded by the singular events. Examples of the singular events of the speaker include a cough, a sneeze, and voice or noise unrelated to the phone conversation. The voice or noise unrelated to the phone conversation may include ambient noise intruding into the phone of the speaker, and the voice of the speaker talking to a person not involved in the phone conversation.

The present invention has been accomplished in view of the foregoing problem. The present invention provides a technique for improving identification accuracy of a section in which a person taking part in a conversation (hereinafter, conversation participant) is expressing a specific emotion.

### Solution to Problem

Some aspects of the present invention are configured as follows, to solve the foregoing problem.

A first aspect relates to a conversation analysis device. The conversation analysis device according to the first aspect including:

a transition detection unit that detects a plurality of predetermined transition patterns of an emotional state on a basis of data related to a voice in a target conversation, with respect to each of a plurality of conversation participants;

an identification unit that identifies a start point combination and an end point combination on a basis of the plurality of predetermined transition patterns detected by the transition detection unit, the start point combination and the end point combination each being a predetermined combination of the predetermined transition patterns of the plurality of conversation participants that satisfy a predetermined positional condition; and

a section determination unit that determines a start time and an end time on a basis of a temporal position of the start point combination and the end point combination identified by the identification unit in the target conversation, to thereby determine a specific emotion section defined by the start time and the end time and representing a specific emotion of the participant of the target conversation.

A second aspect relates to a conversation analysis method performed by at least one computer. The conversation analysis method according to the second aspect including:

detecting a plurality of predetermined transition patterns of an emotional state on a basis of data related to a voice in a target conversation, with respect to each of a plurality of conversation participants;

identifying a start point combination and an end point combination on a basis of the plurality of predetermined transition patterns detected, the start point combination and the end point combination each being a predetermined combination of the predetermined transition patterns of the plurality of conversation participants that satisfy a predetermined positional condition; and

determining a start time and an end time of a specific emotion section representing a specific emotion of the participant of the target conversation, on a basis of a temporal position of the start point combination and the end point combination identified in the target conversation.

Other aspects of the present invention may include a computer-readable recording medium having the mentioned program recorded thereon. The recording medium includes a tangible non-transitory medium.

### Advantageous Effects of Invention

With the foregoing aspects of the present invention, a technique for improving identification accuracy of a section in which a conversation participant is expressing a specific emotion can be obtained.

### BRIEF DESCRIPTION OF DRAWINGS

These and other objects, features, and advantages will become more apparent through exemplary embodiments described hereunder with reference to the accompanying drawings.

FIG. 1 is a schematic drawing showing a configuration of a contact center system according to a first exemplary embodiment.

FIG. 2 is a block diagram showing a configuration of a call analysis server according to the first exemplary embodiment.

FIG. 3 is a schematic diagram showing an example of a determination process of a specific emotion section.

FIG. 4 is a schematic diagram showing another example of the determination process of the specific emotion section.

FIG. 5 is a diagram showing an example of an analysis result screen.

FIG. 6 is a flowchart showing an operation performed by the call analysis server according to the first exemplary embodiment.

FIG. 7 is a schematic diagram showing an actual example of the specific emotion section.

FIG. 8 is a schematic diagram showing another actual example of the specific emotion section.

FIG. 9 is a schematic diagram showing an actual example of a singular event of a speaker.

FIG. 10 is a block diagram showing a configuration of a call analysis server according to a second exemplary embodiment.

FIG. 11 is a schematic diagram showing an example of a smoothing process according to the second exemplary embodiment.

FIG. 12 is a flowchart showing an operation performed by the call analysis server according to a third exemplary embodiment.

### DESCRIPTION OF EMBODIMENTS

Hereafter, exemplary embodiments of the present invention will be described. The following exemplary embodiments are merely examples, and the present invention is in no way limited to the configuration according to the following exemplary embodiments.

A conversation analysis device according to the exemplary embodiment includes,
a transition detection unit that detects a plurality of predetermined transition patterns of an emotional state on a basis of data related to a voice in a target conversation, with respect to each of a plurality of conversation participants; an identification unit that identifies a start point combination and an end point combination on a basis of the plurality of predetermined transition patterns detected by the transition detection unit, the start point combination and the end point combination each being a predetermined combination of the predetermined transition patterns of the plurality of conversation participants that satisfy a predetermined positional condition; and a section determination unit that determines a start time and an end time on a basis of a temporal position of the start point combination and the end point combination identified by the identification unit in a target conversation, to thereby determine a specific emotion section defined by the start time and the end time and representing a specific emotion of the participant of the target conversation.

A conversation analysis method according to the exemplary embodiment includes,

detecting a plurality of predetermined transition patterns of an emotional state on a basis of data related to a voice in a target conversation, with respect to each of a plurality of conversation participants;
identifying a start point combination and an end point combination on a basis of the plurality of predetermined transition patterns detected, the start point combination and the end point combination each being a predetermined combination of the predetermined transition patterns of the plurality of conversation participants that satisfy a predetermined positional condition; and

determining a start time and an end time of a specific emotion section representing a specific emotion of the participant of the target conversation, on a basis of a temporal position of the start point combination and the end point combination identified in the target conversation.

The conversation refers to a situation where two or more speakers talk to each other to declare what they think, through verbal expression. The conversation may include a case where the conversation participants directly talk to each other, for example at a bank counter or at a cash register of a shop. The conversation may also include a case where the participants of the conversation located away from each other talk, for example a conversation over the phone or a TV conference. Here, the voice may also include a sound created by a non-human object, and voice or sound from other sources than the target conversation, in addition to the voice of the conversation participants. Further, data associated with the voice include voice data, and data obtained by processing the voice data.

In the exemplary embodiments, a plurality of predetermined transition patterns of an emotional state are detected, with respect to each of the conversation participants. The predetermined transition pattern of the emotional state refers to a predetermined form of change of the emotional state. The emotional state refers to a mental condition that a person may feel, for example dissatisfaction (anger), satisfaction, interest, and being moved. In the exemplary embodiments, the emotional state also includes a deed, such as apology, that directly derives from a certain mental state (intention to apologize). For example, transition from a normal state to a dissatisfied (angry) state, transition from the dissatisfied state to the normal state, and transition from the normal state to apology correspond to the predetermined transition pattern. In the exemplary embodiments, the predetermined transition pattern is not specifically limited provided that the transition represents a change in emotional state associated with a specific emotion of the conversation participant who is the subject of the detection.

In the exemplary embodiments, further, start point combinations and end point combinations are identified on the basis of the plurality of predetermined transition patterns detected as above. The start point combination and the end point combination each refer to a combination specified in advance, of the predetermined transition patterns respectively detected with respect to the conversation participants. Here, the predetermined transition patterns associated with the combination should satisfy a predetermined positional condition. The start point combination is used to determine the start point of a specific emotion section to be eventually determined, and the end point combination is used to determine the end point of the specific emotion section. The predetermined positional condition is defined on the basis of the time difference or the number of utterance sections, between the predetermined transition patterns associated with the combination. The predetermined positional condition is determined, for example, on the basis of a longest time range in which a natural dialogue can be exchanged. Such a time range may be defined, for example, by a point where the predetermined transition pattern is detected in one conversation participant and a point where the predetermined transition pattern is detected in the other conversation participant.

In the exemplary embodiments, further, the start time and the end time of the specific emotion section representing the specific emotion of the participant of the target conversation are determined. The determination is performed on the basis of the temporal positions of the start point combination and the end point combination identified in the target conversation. Thus, in the exemplary embodiments the combination of the changes in emotional state between a plurality of conversation participants is taken up, to determine the section representing the specific emotion of the conversation participants.

Accordingly, the exemplary embodiments minimize the impact of misrecognition that may take place in an emotion recognition process. A specific emotion may be erroneously detected at a position where the specific emotion does not normally exist, owing to misrecognition in the emotion recognition process. However, the misrecognized specific emotion is excluded from the materials for determining the specific emotion section, when the specific emotion does not match the start point combination or the end point combination.

The exemplary embodiments also minimize the impact of the singular events incidental to the conversation participants. This is because the singular event is also excluded from the determination of the specific emotion section, when the singular event does not match the start point combination or the end point combination.

Further, in the exemplary embodiments the start time and the end time of the specific emotion section are determined on the basis of the combinations of the changes in emotional state of the plurality of conversation participants. Therefore, the local sections in the target conversation can be acquired with higher accuracy. Consequently, the exemplary embodiments can improve the identification accuracy of the section representing the specific emotion of the conversation participants.

Hereunder, the exemplary embodiments will be described in further details. The detailed exemplary embodiments include a first to third exemplary embodiments. The following exemplary embodiments represent the case where the foregoing conversation analysis device and the conversation analysis method are applied to a contact center system. In the following detailed exemplary embodiments, therefore, the phone conversation made in the contact center between a customer and an operator is to be analyzed. The call will refer to a speech made between a speaker and another speaker, during a period from connection of the phones of the respective speakers to disconnection thereof. The conversation participants are the speakers on the phone, namely the customer and the operator. In the following detailed exemplary embodiment, in addition, the section in which the dissatisfaction (anger) of the customer is expressed is determined as specific emotion section. However, this exemplary embodiment is not intended to limit the specific emotion utilized for determining the section. For example, the section representing other types of specific emotion, such as satisfaction of the customer, degree of interest of the customer, or stressful feeling of the operator, may be determined as specific emotion section.

The conversation analysis device and the conversation analysis method are not only applicable to the contact center system that handles the call data, but also to various systems that handle conversation data. For example, the conversation analysis device and method are applicable to a phone conversation management system of a section in the company other than the contact center. In addition, the conversation analysis device and method are applicable to a personal computer (PC) and a terminal such as a landline phone, a mobile phone, a tablet terminal, or a smartphone, which are privately owned. Further, examples of the conversation data include data representing a conversation between a clerk and a customer at a bank counter or a cash register of a shop.

### First Exemplary Embodiment

### [System Configuration]

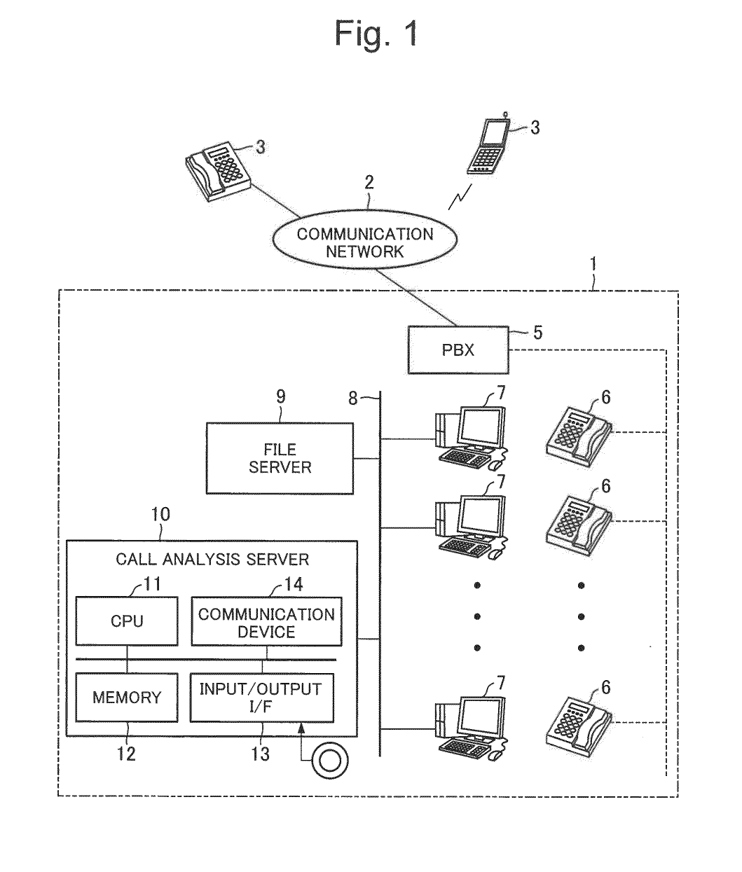

FIG. 1 is a schematic drawing showing a configuration example of the contact center system according to a first exemplary embodiment. The contact center system 1 according to the first exemplary embodiment includes a switchboard (PBX) 5, a plurality of operator phones 6, a plurality of operator terminals 7, a file server 9, and a call analysis server 10. The call analysis server 10 includes a configuration corresponding to the conversation analysis device of the exemplary embodiment.

The switchboard 5 is communicably connected to a terminal (customer phone) 3 utilized by the customer, such as a PC, a landline phone, a mobile phone, a tablet terminal, or a smartphone, via a communication network 2. The communication network 2 is, for example, a public network or a wireless communication network such as the internet or a public switched telephone network (PDTN). The switchboard 5 is connected to each of the operator phones 6 used by the operators of the contact center. The switchboard 5 receives a call from the customer and connects the call to the operator phone 6 of the operator who has picked up the call.

The operators respectively utilize the operator terminals 7. Each of the operator terminals 7 is a general-purpose computers such as a PC connected to a communication network 8, for example as a local area network (LAN), in the contact center system 1. The operator terminals 7 each record, for example, voice data of the customer and voice data of the operator in the phone conversation between the operator and the customer. The voice data of the customer and the voice data of the operator may be separately generated from mixed voices through a predetermined speech processing method. Here, this exemplary embodiment is not intended to limit the recording method and recording device of the voice data. The voice data may be generated by another device (not shown) than the operator terminal 7.

The file server 9 is constituted of a generally known server computer. The file server 9 stores the call data representing the phone conversation between the customer and the operator, together with identification information of the call. The call data includes time information and pairs of the voice data of the customer and the voice data of the operator. The voice data may include voices or sounds inputted through the customer phone 3 and the operator terminal 7, in addition to the voices of the customer and the operator. The file server 9 acquires the voice data of the customer and the voice data of the operator from other devices that record the voices of the customer and the operator, for example the operator terminals 7.

The call analysis server 10 determines the specific emotion section representing the dissatisfaction of the customer with respect to each of the call data stored in the file server 9, and outputs information indicating the specific emotion section. The call analysis server 10 may display such information on its own display device. Alternatively, the call analysis server 10 may display the information on the browser of the user terminal using a WEB server function, or print the information with a printer.

The call analysis server 10 has, as shown in FIG. 1, a hardware configuration including a central processing unit (CPU) 11, a memory 12, an input/output interface (I/F) 13, and a communication device 14. The memory 12 may be, for example, a random access memory (RAM), a read only memory (ROM), a hard disk, or a portable storage medium. The input/output I/F 13 is connected to a device that accepts inputs from the user such as a keyboard or a mouse, a display device, and a device that provides information to the user such as a printer. The communication device 14 makes communication with the file server 9 through the communication network 8. However, the hardware configuration of the call analysis server 10 is not specifically limited.

### [Processing Arrangement]

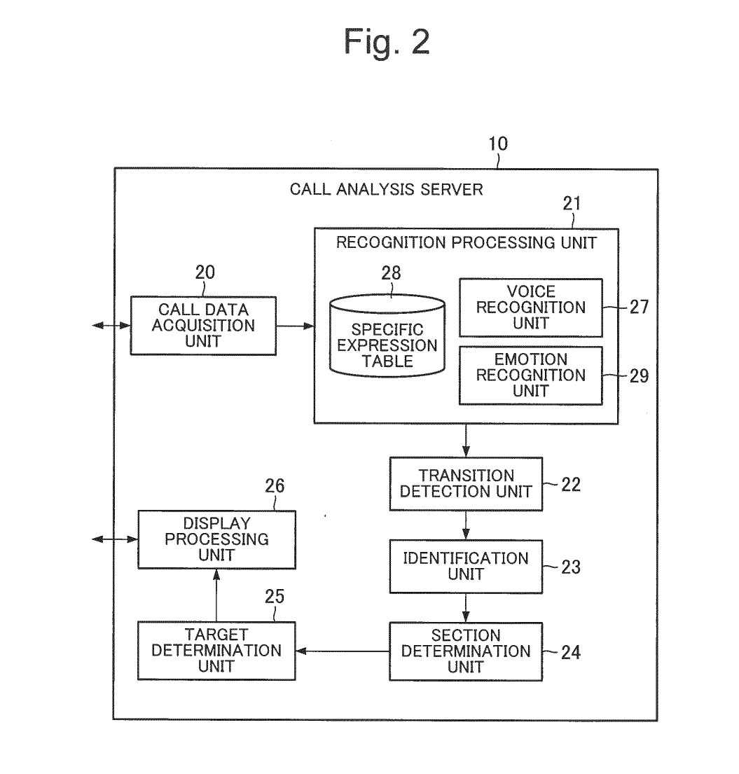

FIG. 2 is a block diagram showing a configuration example of the call analysis server 10 according to the first exemplary embodiment. The call analysis server 10 according to the first exemplary embodiment includes a call data acquisition unit 20, a recognition processing unit 21, a transition detection unit 22, an identification unit 23, a section determination unit 24, a target determination unit 25, and a display processing unit 26. These processing units may be realized, for example, by the CPU 11 upon executing the program stored in the memory 12. Here, the program may be installed and stored in the memory 12, for example from a portable recording medium such as a compact disc (CD) or a memory card, or another computer on the network, through the input/output I/F 13.

The call data acquisition unit 20 acquires, from the file server 9, the call data of a plurality of calls to be analyzed, together with the identification information of the corresponding call. The call data may be acquired through the communication between the call analysis server 10 and the file server 9, or through a portable recording medium.

The recognition processing unit 21 includes a voice recognition unit 27, a specific expression table 28, and an emotion recognition unit 29. The recognition processing unit 21 estimates the specific emotional state of each speaker of the target conversation on the basis of the data representing the target conversation acquired by the call data acquisition unit 20, by using the cited units. The recognition processing unit 21 then detects individual emotion sections each representing a specific emotional state on the basis of the estimation, with respect to each speaker of the target conversation. Through the detection, the recognition processing unit 21 acquires the start time and the end time, and the type of the specific emotional state (e.g., anger and apology), of each of the individual emotion sections. The units in the recognition processing unit 21 are also realized upon execution of the program, like other processing units. The specific emotional state estimated by the recognition processing unit 21 is the emotional state included in the predetermined transition pattern.

The recognition processing unit 21 may detect the utterance sections of the operator and the customer in the voice data of the operator and the customer included in the call data. The utterance section refers to a continuous region where the speaker is outputting the voice. For example, a section where amplitude wider than a predetermined value is maintained in the voice waveform of the speaker is detected as utterance section. Normally, the conversation is composed of the utterance sections and silent sections produced by each of the speakers. Through such detection, the recognition processing unit 21 acquires the start time and the end time of each utterance section. In this exemplary embodiment, the detection method of the utterance section is not specifically limited. The utterance section may be detected through the voice recognition performed by the voice recognition unit 27. In addition, the utterance section of the operator may include a sound inputted by the operator terminal 7, and the utterance section of the customer may include a sound inputted by the customer phone 3.

The voice recognition unit 27 recognizes the voice with respect to each of the utterance sections in the voice data of the operator and the customer contained in the call data. Accordingly, the voice recognition unit 27 acquires, from the call data, voice text data and speech time data associated with the operator's voice and the customer's voice. Here, the voice text data refers to character data converted into a text from the voice outputted from the customer or operator. The speech time represents the time when the speech corresponding to the voice text data has been made, and includes the start time and the end time of the utterance section from which the voice text data has been acquired. In this exemplary embodiment, the voice recognition may be performed through a known method. The voice recognition process itself and the voice recognition parameters to be employed for the voice recognition are not specifically limited.

The specific expression table 28 contains specific expression data that can be designated according to the call search criteria and the section search criteria. The specific expression data is stored in the form of character data. The specific expression table 28 contains, for example, apology expression data such as “I am very sorry” and gratitude expression data such as “thank you very much” as specific expression data. For example, when the specific emotional state includes “apology of the operator”, the recognition processing unit 21 searches the voice text data of the utterance sections of the operator that obtained by the voice recognition unit 27. Upon detecting the apology expression data contained in the specific expression table 28 in the voice text data, the recognition processing unit 21 determines the utterance section that includes the apology expression data as individual emotion section.

The emotion recognition unit 29 recognizes the emotion with respect to the voice data of at least one of the operator and the customer contained in the call data representing the target conversation. For example, the emotion recognition unit 29 acquires prosodic feature information from the voice in each of the utterance sections. The emotion recognition unit 29 then decides whether the utterance section represents the specific emotional state to be recognized, by using the prosodic feature information. Examples of the prosodic feature information include a basic frequency and a voice power. In this exemplary embodiment the method of emotion recognition is not specifically limited, and a known method may be employed for the emotion recognition (see reference cited below).

Reference Example: Narichika Nomoto et al., “Estimation of Anger Emotion in Spoken Dialogue Using Prosody and Conversational Temporal Relations of Utterance”, Acoustic Society of Japan, Conference Paper of March 2010, pages 89 to 92.

The emotion recognition unit 29 may decide whether the utterance section represents the specific emotional state, using the identification model based on the support vector machine (SVM). To be more detailed, in the case where the “anger of customer” is included in the specific emotional state, the emotion recognition unit 29 may store in advance an identification model. The identification model may be obtained by providing the prosodic feature information of the utterance section representing the “anger” and “normal” as learning data, to allow the identification model to learn to distinguish between the “anger” and “normal”. The emotion recognition unit 29 may thus contain the identification model that matches the specific emotional state to be recognized. In this case, the emotion recognition unit 29 can decide whether the utterance section represents the specific emotional state, by giving the prosodic feature information of the utterance section to the identification model. The recognition processing unit 21 determines the utterance section decided by the emotion recognition unit 29 to be representing the specific emotional state as individual emotion section.

In the foregoing example the voice recognition unit 27 and the emotion recognition unit 29 perform the recognition process with respect to the utterance section. Alternatively, for example, a silent section may be utilized to estimate the specific emotional state, on the basis of the tendency that when a person is dissatisfied the interval between the utterances is prolonged. Thus, in this exemplary embodiment the detection method of the individual emotion section to be performed by the recognition processing unit 21 is not specifically limited. Accordingly, known methods other than those described above may be employed to detect the individual emotion section.

The transition detection unit 22 detects a plurality of predetermined transition patterns with respect to each speaker of the target conversation, together with information of the temporal position in the conversation. Such detection is performed on the basis of the information related to the individual emotion section determined by the recognition processing unit 21. The transition detection unit 22 contains information regarding the plurality of predetermined transition patterns with respect to each speaker, and detects the predetermined transition pattern on the basis of such information. The information regarding the predetermined transition pattern may include, for example, a pair of a type of the specific emotional state before the transition and a type of the specific emotional state after the transition.

The transition detection unit 22 detects, for example, a transition pattern from a normal state to a dissatisfied state and from the dissatisfied state to the normal state or a satisfied state, as plurality of predetermined transition patterns of the customer. Likewise, the transition detection unit 22 detects a transition pattern from a normal state to apology, and from the apology to the normal state or a satisfied state, as plurality of predetermined transition patterns of the operator.

The identification unit 23 contains in advance information regarding the start point combinations and the end point combinations. With such information, the identification unit 23 identifies the start point combinations and the end point combinations on the basis of the plurality of predetermined transition patterns detected by the transition detection unit 22, as described above. The information of the start point combination and the end point combination stored in the identification unit 23 includes the information of the combination of the predetermined transition patterns of each speaker, as well as the predetermined positional condition. The predetermined positional condition stored in the identification unit 23 specifies, for example, a time difference between the transition patterns. For example, when the transition pattern of the customer from a normal state to anger is followed by the transition pattern of the operator from a normal state to apology, the time difference therebetween is specified as within two seconds.

In this exemplary embodiment, the identification unit 23 identifies, for example, a combination of a transition pattern of the customer from a normal state to a dissatisfied state and that of the operator from a normal state to apology as start point combination. In addition, the identification unit 23 identifies a combination of a transition pattern of the customer from a dissatisfied state to a normal state and that of the operator from apology to a normal state or satisfied state, as end point combination.

The section determination unit 24 determines, in order to determine the specific emotion section as above, the start time and the end time of the specific emotion section. Such determination is made on the basis of the temporal positions in the target conversation, associated with the start point combination and the end point combination identified by the identification unit 23. In this exemplary embodiment, the section determination unit 24 determines, for example, a section representing the dissatisfaction of the customer as specific emotion section. The section determination unit 24 may determine the start times on the basis of the respective start point combinations, and the end times on the basis of the respective end point combinations. In this case, a section between a start time and an end time later than and closest to the start time is determined as specific emotion section.

However, when a specific emotion section and another specific emotion section determined as above are temporally close to each other, a section defined by the start point of the leading specific emotion section and the end point of the trailing specific emotion section may be determined as specific emotion section. In this case, the section determination unit 24 determines the specific emotion section through a smoothing process as described hereunder.

The section determination unit 24 determines possible start times and possible end times on the basis of the temporal positions in the target conversation, associated with the start point combination and the end point combination identified by the identification unit 23. The section determination unit 24 then excludes, from the possible start times and the possible end times alternately aligned temporally, a second possible start time located subsequent to the leading possible start time. Here, the second possible start time is located within a predetermined time or within a predetermined number of utterance sections after the leading possible start time. The section determination unit 24 also excludes the possible start times and the possible end times located between the leading possible start time and the second possible start time. Then the section determination unit 24 determines the remaining possible start time and the remaining possible end time as start time and end time, respectively.

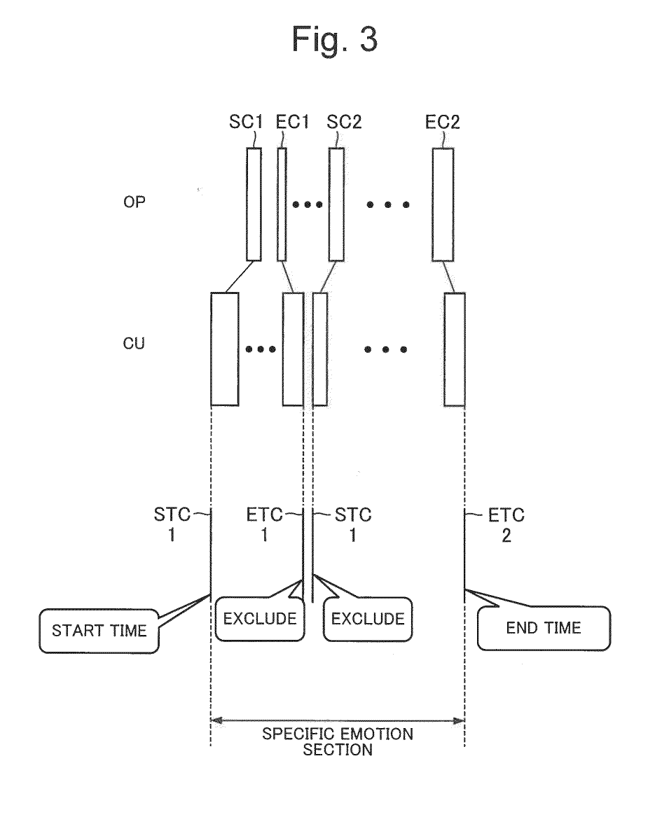

FIG. 3 is a schematic diagram showing an example of the determination process of the specific emotion section. In FIG. 3, OP denotes the operator and CU denotes the customer. In the example shown in FIG. 3, a possible start time STC1 is acquired on the basis of a start point combination SC1, and a possible start time STC2 is acquired on the basis of a start point combination SC2. In addition, a possible end time ETC1 is acquired on the basis of an end point combination EC1, and a possible end time ETC2 is acquired on the basis of an end point combination EC2. In FIG. 3, STC2 is located within a predetermined time or within a predetermined number of utterance sections after STC1, and therefore STC2 and ETC1, which is located between STC1 and STC2, are excluded. Thus, STC1 is determined as start time and ETC2 is determined as end time.

There may be cases where the possible start times and the possible end times are not alternately aligned temporally. In such a case, the section determination unit 24 determines the specific emotion section through the smoothing process described below. The section determination unit 24 excludes at least one of the following. One is a plurality of possible start times temporally aligned without including a possible end time therebetween, except the leading one of the possible start times aligned. Another is a plurality of possible end times temporally aligned without including a possible start time therebetween, except the trailing one of the possible end times aligned. Then the section determination unit 24 determines the remaining possible start time and the remaining possible end time as start time and end time, respectively.

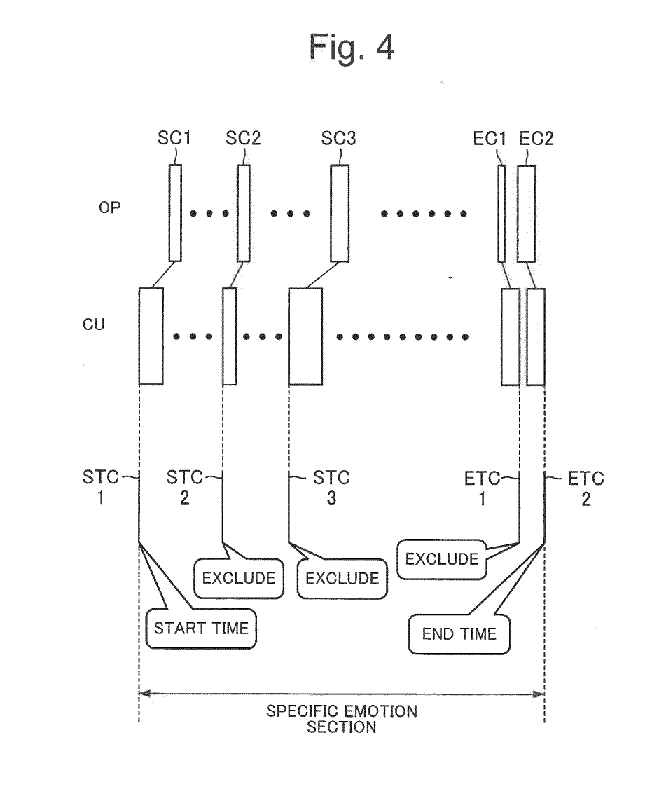

FIG. 4 is a schematic diagram showing another example of the determination process of the specific emotion section. In the example shown in FIG. 4, STC1, STC2, and STC3 are temporally aligned without including a possible end time therebetween, and ETC1 and ETC2 are temporally aligned without including a possible start time therebetween. In this case, the possible start times other than the leading possible start time STC1, namely STC2 and STC3, are excluded, and the possible end time other than the trailing possible end time ETC2, namely ETC1, is excluded. Thus, the remaining possible start time STC1 is determined as start time, and the remaining possible end time ETC2 is determined as end time.

In the examples shown in FIG. 3 and FIG. 4, the possible start time is set on the start time of the leading specific emotion section included in the start point combination. The possible end time is set on the end time of the trailing specific emotion section included in the end point combination. In this exemplary embodiment, however, the determination method of the possible start time and the possible end time based on the start point combination and the end point combination is not specifically limited. The midpoint of a largest range in the specific emotion section included in the start point combination may be designated as possible start time. Alternatively, a time determined by subtracting a margin time from the start time of the leading specific emotion section included in the start point combination may be designated as possible start time. Further, a time determined by adding a margin time to the end time of the trailing specific emotion section included in the end point combination may be designated as possible end time.

The target determination unit 25 determines a predetermined time range as cause analysis section representing the cause of the specific emotion that has arisen in the speaker of the target conversation. The time range is defined about a reference time acquired from the specific emotion section determined by the section determination unit 24. This is because the cause of the specific emotion is highly likely to lie in the vicinity of the head portion of the section in which the specific emotion is expressed. Accordingly, it is preferable that the reference time is set in the vicinity of the head portion of the specific emotion section. The reference time may be set, for example, at the start time of the specific emotion section. The cause analysis section may be defined as a predetermined time range starting from the reference time, a predetermined time range ending at the reference time, or a predetermined time range including the reference time at the center.

The display processing unit 26 generates drawing data in which a plurality of first drawing elements, a plurality of second drawing elements, and a third drawing element are aligned in a chronological order in the target conversation. The plurality of first drawing elements represents a plurality of individual emotion sections of a first speaker determined by the recognition processing unit 21. The plurality of second drawing elements represents a plurality of individual emotion sections of a second speaker determined by the recognition processing unit 21. The third drawing element represents the cause analysis section determined by the target determination unit 25. Accordingly, the display processing unit 26 may also be called drawing data generation unit. The display processing unit 26 causes the display device to display an analysis result screen on the basis of such drawing data, the display device being connected to the call analysis server 10 via the input/output I/F 13. The display processing unit 25 may also be given a WEB server function, so as to cause a WEB client device to display the drawing data. Further, the display processing unit 26 may include a fourth drawing element representing the specific emotion section determined by the section determination unit 24, in the drawing data.

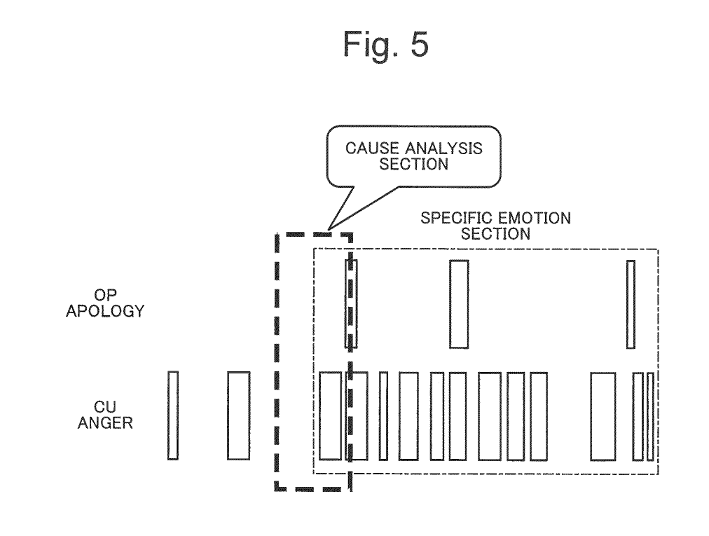

FIG. 5 illustrates an example of the analysis result screen. In the example shown in FIG. 5, the individual emotion sections respectively representing the apology of the operator (OP) and the anger of the customer (CU), the specific emotion section, and the cause analysis section are included. Although the specific emotion section is indicated by dash-dot lines in FIG. 5 for the sake of clarity, the display of the specific emotion section may be omitted.

### OPERATION EXAMPLE

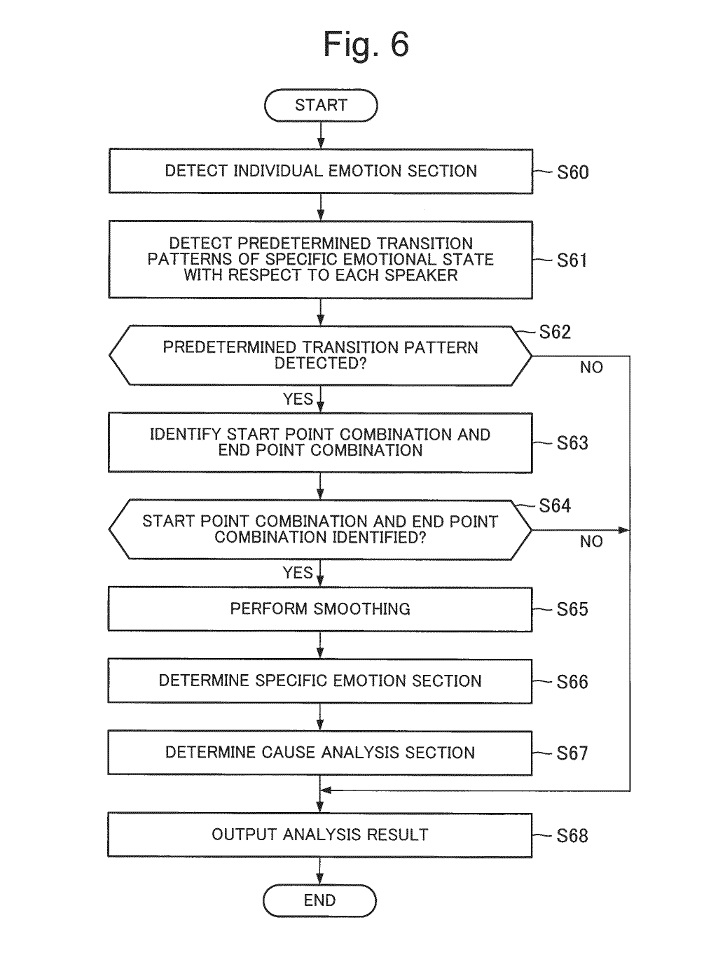

Hereunder, the conversation analysis method according to the first exemplary embodiment will be described with reference to FIG. 6. FIG. 6 is a flowchart showing the operation performed by the call analysis server 10 according to the first exemplary embodiment. Here, it is assumed that the call analysis server 10 has already acquired the data of the conversation to be analyzed.

The call analysis server 10 detects the individual emotion sections each representing the specific emotional state of either speaker, from the call data to be analyzed (S60). Such detection is performed on the basis of the result obtained through the voice recognition process and the emotion recognition process. As result of the detection, the call analysis server 10 acquires, for example, the start time and the end time with respect to each of the individual emotion section.

The call analysis server 10 extracts a plurality of predetermined transition patterns of the specific emotional state, with respect to each speaker, out of the individual emotion sections acquired at S60 (S61). Such extraction is performed on the basis of information related to the plurality of predetermined transition patterns stored in advance with respect to each speaker. In the case where the predetermined transition patterns have not been detected (NO at S62), the call analysis server 10 generates a display of the analysis result screen showing the information related to the plurality of predetermined transition patterns of each speaker, detected at S60 (S68). The call analysis server 10 may print the mentioned information on a paper medium (S68).

In the case where the predetermined transition patterns have been detected (YES at S62), the call analysis server 10 identifies the start point combinations and the end point combinations (S63). These combinations are each composed of the predetermined transition patterns of the respective speakers, and the identification is performed on the basis of the plurality of predetermined transition patterns detected at S61. In the case where the start point combinations and the end point combinations have not been identified (NO at S64), the call analysis server 10 generates a display of the analysis result screen showing the information related to the plurality of predetermined transition patterns of each speaker, detected at S60 (S68) as described above.

In the case where the start point combinations and the end point combinations have been identified (YES at S64), the call analysis server 10 performs the smoothing of the possible start times and the possible end times (S65). The possible start times can be acquired from the start point combinations, and the possible end times can be acquired from the end point combinations. Through the smoothing process, the possible start times and the possible end times, one of which is to be designated as start time and end time of the specific emotion section, are narrowed down. In the case where all of the possible start times and the possible end times can be set as start time and end time, the smoothing process may be skipped.

To be more detailed, the call analysis server 10 excludes, from the possible start times and the possible end times alternately aligned temporally, the second possible start time located subsequent to the leading possible start time. The second possible start time is located within a predetermined time or within a predetermined number of utterance sections after the leading possible start time. The call analysis server 10 also excludes the possible start times and the possible end times located between the leading possible start time and the second possible start time. In addition, the call analysis server 10 excludes at least one of the following. One is a plurality of possible start times temporally aligned without including a possible end time therebetween, except the leading one of the possible start times aligned. Another is a plurality of possible end times temporally aligned without including a possible start time therebetween, except the trailing one of the possible end times aligned.

The call analysis server 10 determines the possible start time and the possible end time that remain after the smoothing of S65 has been performed as start time and end time of the specific emotion section (S66).

Further, the call analysis server 10 determines the predetermined time range defined about the reference time acquired from the specific emotion section determined at S66 as cause analysis section. The cause analysis section is the section representing the cause of the specific emotion that has arisen in the speaker of the target conversation (S67).

The call analysis server 10 generates, a display of the analysis result screen in which the individual emotion sections of each speaker detected at S60 and the cause analysis section determined at S67 are aligned in a chronological order in the target conversation (S68). The call analysis server 10 may print the information representing the content of the analysis result screen on a paper medium (S68).

Although a plurality of steps is sequentially listed in the flowchart of FIG. 6, the process to be performed according to this exemplary embodiment is not limited to the sequence shown in FIG. 6.

### [Advantageous Effects of First Exemplary Embodiment]

As described above, in the first exemplary embodiment the individual emotion sections representing the specific emotional state of each speaker are detected on the basis of the data related to the voice of each speaker. Then the plurality of predetermined transition patterns of the specific emotional state are detected with respect to each speaker, out of the individual emotion sections detected as above. In the first exemplary embodiment, further, the start point combinations and the end point combinations, each composed of the predetermined transition patterns of the respective speakers, are identified. This identification is performed on the basis of the plurality of predetermined transition patterns detected as above. The specific emotion section representing the specific emotion of the speaker is then determined on the basis of the start point combinations and the end point combinations. Thus, the section representing the specific emotion of the speaker is determined by using the combinations of the changes in emotional state of a plurality of speakers, in the first exemplary embodiment.

Accordingly, the first exemplary embodiment minimizes the impact of misrecognition that may take place in an emotion recognition process, in the determination process of the specific emotion section. In addition, the first exemplary embodiment also minimizes the impact of the singular event incidental to the speakers. Further, in the first exemplary embodiment the start time and the end time of the specific emotion section are determined on the basis of the combinations of the changes in emotional state of the plurality of speakers. Therefore, the local specific emotion sections in the target conversation can be acquired with higher accuracy. Consequently, the first exemplary embodiment can improve the identification accuracy of the section representing the specific emotion of the speakers of the conversation.

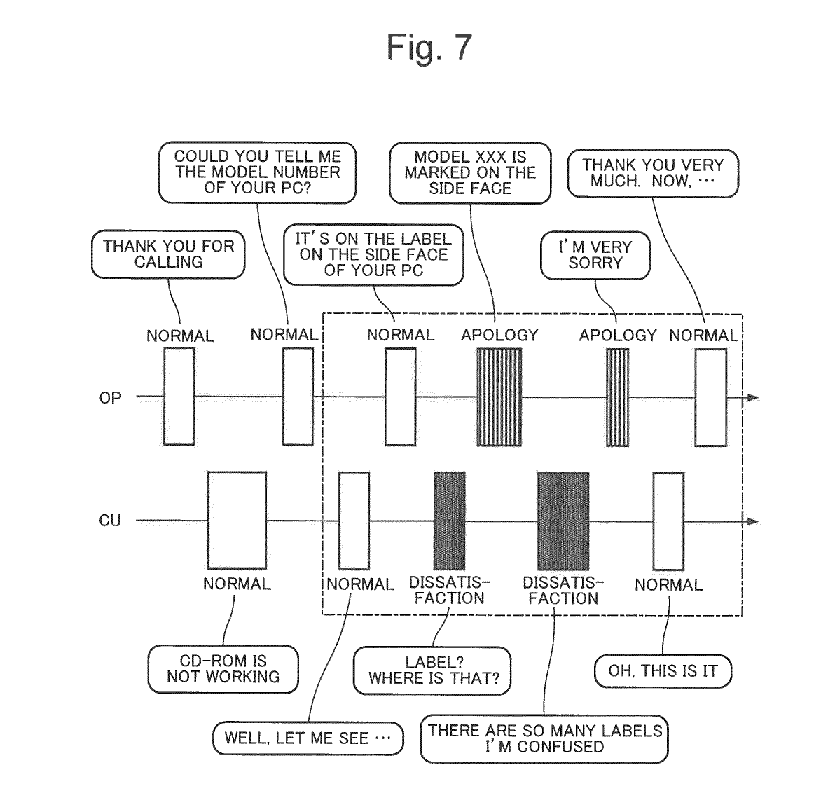

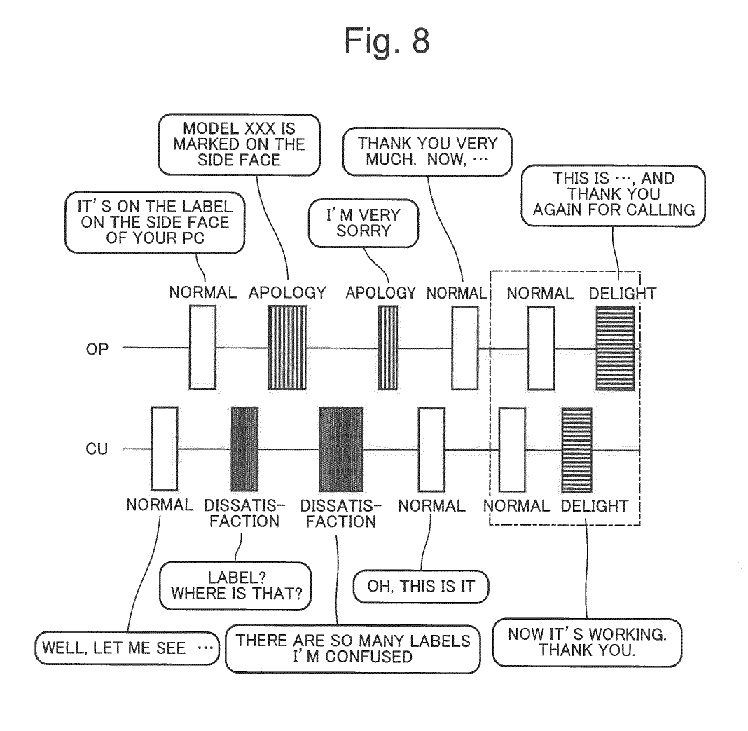

FIG. 7 and FIG. 8 are schematic diagrams each showing an actual example of the specific emotion section. In the example shown in FIG. 7, a section representing the dissatisfaction of the customer is determined as specific emotion section. A transition from a normal state to a dissatisfied state and a transition from the dissatisfied state to the normal state on the part of the customer (CU) are detected as predetermined transition patterns. In addition, a transition from a normal state to apology and a transition from the apology to the normal state on the part of the operator are detected as predetermined transition patterns. Out of such predetermined transition patterns, the combination of the transition from the normal state to the dissatisfied state on the part of the customer (CU) and the transition from the normal state to the apology on the part of the operator (OP) is identified as start point combination. In addition, the combination of the transition from the apology to the normal state on the part of the operator and the transition from the dissatisfied state to the normal state on the part of the customer is identified as end point combination. As result, as indicated by dash-dot lines in FIG. 7, the portion between the start time obtained from the start point combination and the end time obtained from the end point combination is determined as section in which the dissatisfaction of the customer is expressed (specific emotion section).

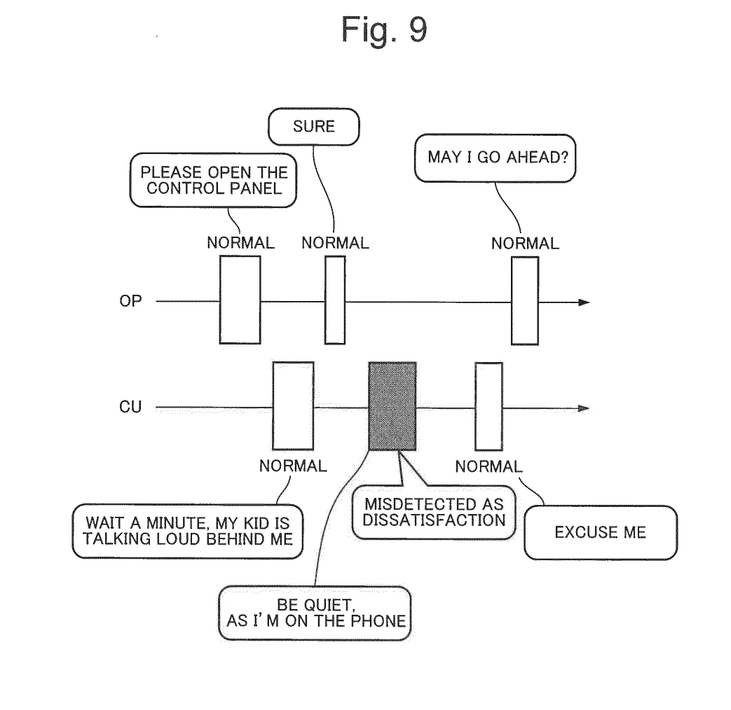

Thus, in the first exemplary embodiment, the section in which the dissatisfaction of the customer is expressed can be estimated on the basis of the combinations of the changes in emotional state in the customer and the operator. Therefore, such estimation is unsusceptible to misdetection with respect to dissatisfaction and apology, as well as to the singular event incidental to the speaker shown in FIG. 9. Consequently, the first exemplary embodiment enables the section representing the dissatisfaction of the customer to be estimated with higher accuracy.

In the example shown in FIG. 8, a section representing the satisfaction (delight) of the customer is determined as specific emotion section. In this case, the combination of the transition from the normal state to a delighted state on the part of the customer and the transition from the normal state to a delighted state on the part of the operator is identified as start point combination. In the example shown in FIG. 8, the portion between the start point combination and the end point of the conversation is determined as section representing the satisfaction (delight) of the customer.

FIG. 9 is a schematic diagram showing an actual example of the singular event of the speaker. In the example shown in FIG. 9, the voice of the speaker “Be quiet, as I'm on the phone” directed to a person other than the speakers (child talking loud behind the speaker) is inputted as utterance of the speaker. In this case, it is probable that this utterance section is recognized as dissatisfaction, in the emotion recognition process. However, the operator remains in the normal state under such a circumstance. The first exemplary embodiment utilizes the combination of the changes in emotional state in the customer and the operator, and therefore the degradation in estimation accuracy due to such a singular event can be prevented.

In the first exemplary embodiment, further, the possible start times and the possible end times are acquired on the basis of the start point combinations and the end point combinations. Then the possible start time and the possible end time that can be respectively designated as start time and end time for defining the specific emotion section are selected out of the acquired possible start times and the possible end times. Here, in the case where the possible start time and the possible end time are directly designated as start time and end time, some of the specific emotion sections may be temporally very close to each other. In addition, some possible start times may be successively aligned without including the possible end time therebetween, and some possible end times may be successively aligned without including the possible start time therebetween. According to the first exemplary embodiment, in such cases the smoothing of the possible start times and the possible end times is performed, to thereby determine an optimum range as specific emotion section. With the first exemplary embodiment, therefore, the local specific emotion sections in the target conversation can be acquired with higher accuracy.

### Second Exemplary Embodiment

The contact center system 1 according to a second exemplary embodiment adopts a novel smoothing process of the possible start times and the possible end times, instead of, or in addition to, the smoothing process according to the first exemplary embodiment. Hereunder, the contact center system 1 according to the second exemplary embodiment will be described focusing on differences from the first exemplary embodiment. The description of the same aspects as those of the first exemplary embodiment will not be repeated.

### [Processing Arrangement]

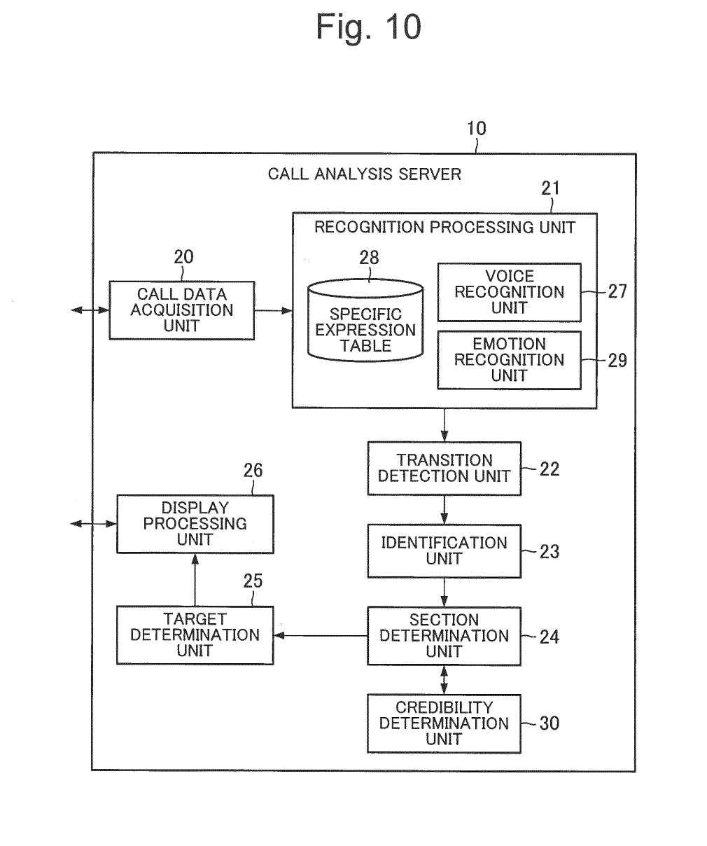

FIG. 10 is a block diagram showing a configuration of the call analysis server 10 according to the second exemplary embodiment. The call analysis server 10 according to the second exemplary embodiment includes a credibility determination unit 30, in addition to the configuration of the first exemplary embodiment. The credibility determination unit 30 may be realized, for example, by the CPU 11 upon executing the program stored in the memory 12, like other functional units.

The credibility determination unit 30 identifies, when the section determination unit 24 determines the possible start times and the possible end times, all the combinations (pairs) of the possible start time and the possible end time. In each of such pairs, the possible start time is located forward and followed by the possible end time. The credibility determination unit 30 then calculates, with respect to each of the pairs, the density of either or both of other possible start times and other possible end times in the time range defined by the corresponding pair. For example, the credibility determination unit 30 counts the number of either or both of other possible start times and other possible end times in the time range defined by the possible start time and the possible end time constituting the pair. Then the credibility determination unit 30 divides the counted number by the time between the possible start time and the possible end time, to thereby obtain the density in the pair. The credibility determination unit 30 then determines a credibility score based on the density, with respect to each of the pairs. The credibility determination unit 30 gives the higher credibility score to the pair, the higher the density is. The credibility determination unit 30 may give a lowest credibility score to a pair in which the number of counts is zero.

The section determination unit 24 determines the possible start times and the possible end times on the basis of the start point combinations and the end point combinations, as in the first exemplary embodiment. Then the section determination unit 24 determines the start time and the end time of the specific emotion section out of the possible start times and the possible end times, according to the credibility score determined by the credibility determination unit 30. For example, when the time ranges of a plurality of pairs of the possible start time and the possible end time overlap, even partially, the section determination unit 24 excludes the pairs other than the pair given the highest credibility score. Then the section determination unit 24 determines the remaining one of the possible start time and the possible end time, as start time and end time.

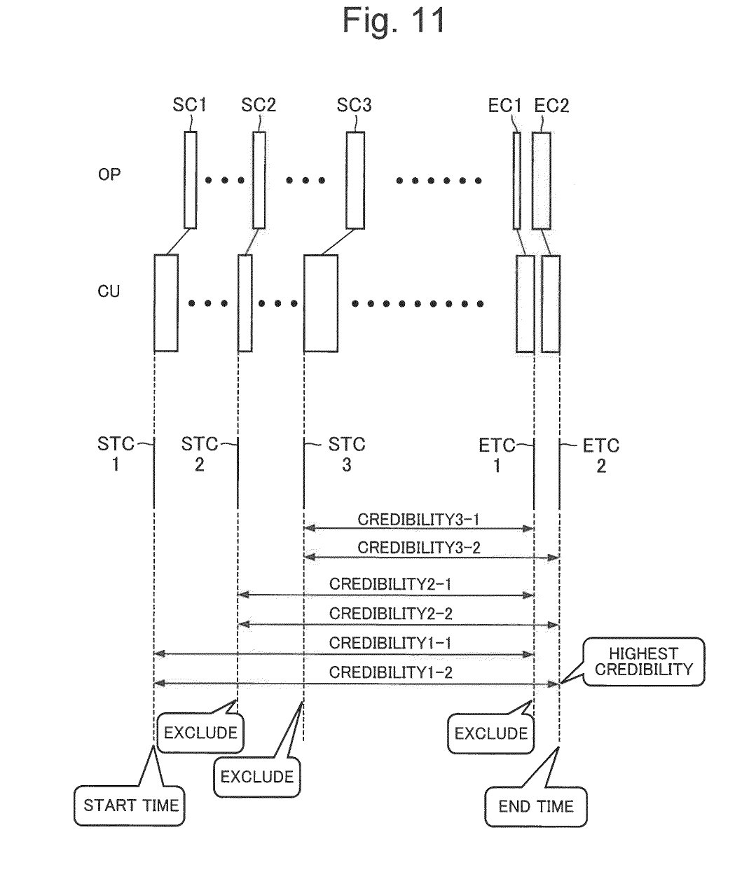

FIG. 11 is a schematic diagram showing an example of the smoothing process according to the second exemplary embodiment. The codes in FIG. 11 respectively denote the same constituents as those of FIG. 4. The credibility determination unit 30 gives the credibility scores 1-1, 1-2, 2-1, 2-2, 3-1, and 3-2 to the respective pairs each composed of the combination of one the possible start times STC1, STC2, and STC3 and one of the possible end times ETC1 and ETC2. Since the time ranges of all of the pairs of the possible start time and the possible end time overlap in FIG. 11, the section determination unit 24 excludes the pairs other than the pair given the highest credibility score. As result, the section determination unit 24 determines the possible start time STC1 as start time, and the possible end time ETC2 as end time.

### OPERATION EXAMPLE

By a conversation analysis method according to the second exemplary embodiment, the smoothing process is performed using the credibility score, at S65 shown in FIG. 6.

### [Advantageous Effects of Second Exemplary Embodiment]

In the second exemplary embodiment, the density of the possible start times and the possible end times in each of the time ranges is calculated, and the credibility score of each pair is determined according to the density. As stated above, the time ranges are respectively defined by the pairs of the possible start time acquired from the start point combination and the possible end time acquired from the end point combination. Then the pair given the highest credibility score, out of the plurality of pairs of the possible start time and the possible end time, the time ranges of which overlap, is determined as the pair having the start time and the end time defining the specific emotion section.

In the second exemplary embodiment, as described above, the time range including the largest number of combinations of the predetermined transition patterns of the emotional state of the speakers per unit time is determined as specific emotion section. Such an arrangement improves the probability that the specific emotion section determined according to the second exemplary embodiment represents the specific emotion.

### Third Exemplary Embodiment

The contact center system 1 according to a third exemplary embodiment utilizes the credibility score determined according to the second exemplary embodiment as credibility score of the specific emotion section. Hereunder, the contact center system 1 according to the third exemplary embodiment will be described focusing on differences from the first and second exemplary embodiments. The description of the same aspects as those of the first and second exemplary embodiments will not be repeated.

### [Processing Arrangement]

The credibility determination unit 30 according to the third exemplary embodiment calculates the density of either or both of the possible start times and the possible end times located in the specific emotion section. As stated above, the possible start times and the possible end times, as well as the specific emotion section, are determined by the section determination unit 24. The credibility determination unit 30 then determines the credibility score according to the calculated density. To calculate the density, the credibility determination unit 30 also utilizes the possible start times and the possible end times that have been excluded. In other words, the credibility determination unit 30 also utilizes the possible start times and the possible end times other than those determined as start time and the end time of the specific emotion section. The calculation method of the density, and the determination method of the credibility score based on the density are the same as those of the second exemplary embodiment.

The section determination unit 24 utilizes the credibility score determined by the credibility determination unit 30 as credibility score of the specific emotion section.

When the drawing data includes the fourth drawing element representing the specific emotion section, the display processing unit 26 may add the credibility score of the specific emotion section determined by the section determination unit 24 to the drawing data.

### OPERATION EXAMPLE

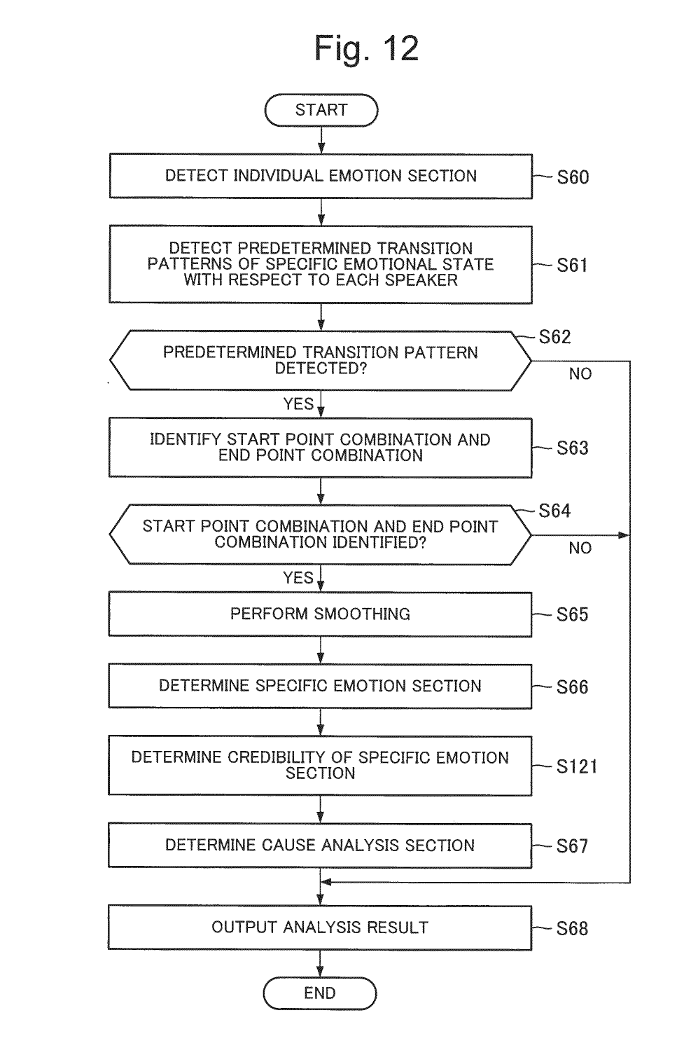

Hereunder, the conversation analysis method according to the third exemplary embodiment will be described with reference to FIG. 12. FIG. 12 is a flowchart showing the operation performed by the call analysis server 10 according to the third exemplary embodiment. In FIG. 12, the same steps as those of FIG. 6 are denoted by the same codes as those of FIG. 6.

In the third exemplary embodiment, the call analysis server 10 determines, between S66 and S67, the credibility score of the specific emotion section determined at S66 (S121). At this step, the same credibility determination method as above is employed.

### [Advantageous Effects of Third Exemplary Embodiment]

In the third exemplary embodiment, the credibility score determined according to the number of combinations of the predetermined transition patterns of the emotional state of the speakers per unit time is given to the specific emotion section. Such an arrangement allows, when a plurality of specific emotion sections are determined, the priority order of the processing of the specific emotion sections to be determined according to the credibility score.

### [Variations]

The call analysis server 10 may be set up with a plurality of computers. For example, the call data acquisition unit 20 and the recognition processing unit 21 may be realized by a computer other than the call analysis server 10. In this case, the call analysis server 10 may include an information acquisition unit, in place of the call data acquisition unit 20 and the recognition processing unit 21. The information acquisition unit serves to acquire the information of the individual emotion sections each representing the specific emotional states of the speakers. Such information corresponds to the result provided by the recognition processing unit 21 regarding the target conversation.

In addition, the specific emotion sections may be narrowed down to a finally determined one, according to the credibility score given to each of the specific emotion sections determined according to the third exemplary embodiment. In this case, for example, only the specific emotion section having a credibility score higher than a predetermined threshold may be finally selected as specific emotion section.

### Other Exemplary Embodiment

The phone call data is the subject of the foregoing exemplary embodiments. However, the conversation analysis device and the conversation analysis method may be applied to devices or systems that handle call data other than the phone conversation. In this case, for example, a recorder for recording the target conversation is installed in the site where the conversation takes place such as a conference room, a bank counter, a cash register of a shop. When the call data is recorded in a form of mixture of voices of a plurality of conversation participants, the data may be subjected to predetermined voice processing, so as to split the data into voice data of each of the conversation participants.

The foregoing exemplary embodiments and the variations thereof may be combined as desired, unless a conflict arises.

A part or the whole of the foregoing exemplary embodiments and the variations thereof may be defined as supplementary notes cited hereunder. However, the exemplary embodiments and the variations are not limited to the following supplementary notes.

### [Supplementary Note 1]

A conversation analysis device including:

a transition detection unit that detects a plurality of predetermined transition patterns of an emotional state on a basis of data related to a voice in a target conversation, with respect to each of a plurality of conversation participants;

an identification unit that identifies a start point combination and an end point combination on a basis of the plurality of predetermined transition patterns detected by the transition detection unit, the start point combination and the end point combination each being a predetermined combination of the predetermined transition patterns of the plurality of conversation participants that satisfy a predetermined positional condition; and

a section determination unit that determines a start time and an end time on a basis of a temporal position of the start point combination and the end point combination identified by the identification unit in the target conversation, to thereby determine a specific emotion section defined by the start time and the end time and representing a specific emotion of the participant of the target conversation.

### [Supplementary Note 2]

The device according to supplementary note 1,

wherein the section determination unit determines a plurality of possible start times and a plurality of possible end times on a basis of the temporal position of the start point combination and the end point combination identified by the identification unit in the target conversation,

wherein the section determination unit excludes either or both of the plurality of possible start times other than a leading possible start time temporally aligned without the possible end time being interposed, and the plurality of possible end times other than a trailing possible end time temporally aligned without the possible start time being interposed, and

wherein the section determination unit determines a remaining possible start time and a remaining possible end time as the start time and the end time.

### [Supplementary Note 3]

The device according to supplementary note 1 or 2,

wherein the section determination unit determines the plurality of possible start times and the plurality of possible end times on a basis of the temporal position of the start point combination and the end point combination identified by the identification unit in the target conversation,

wherein the section determination unit excludes, out of the possible start times and the possible end times alternately aligned temporally, a second possible start time located within a predetermined time or within a predetermined number of utterance sections after the leading possible start time, and the possible start times and the possible end times located between the leading possible start time and the second possible start time, and

wherein the section determination unit determines the remaining possible start time and the remaining possible end time as the start time and the end time.

### [Supplementary Note 4]

The device according to any one of supplementary notes 1 to 3, further including a credibility determination unit that calculates, with respect to each of pairs of the possible start time and the possible end time determined by the section determination unit, density of either or both of other possible start times and other possible end times in a time range defined by a corresponding pair, and determines a credibility score according to the density calculated,

wherein the section determination unit determines the plurality of possible start times and the plurality of possible end times on a basis of the temporal position of the start point combination and the end point combination identified by the identification unit in the target conversation, and determines the start time and the end time out of the possible start times and the possible end times, according to the credibility score determined by the credibility determination unit.

### [Supplementary Note 5]

The device according to any one of supplementary notes 1 to 4, further including:

the credibility determination unit that calculates, with respect to the specific emotion section determined by the section determination unit, density of either or both of the possible start times and the possible end times determined by the section determination unit and located in the specific emotion section, and determines the credibility score according to the calculated density,

wherein the section determination unit determines the plurality of possible start times and the plurality of possible end times on a basis of the temporal position of the start point combination and the end point combination identified by the identification unit in the target conversation, and determines the credibility score determined by the credibility determination unit as credibility score of the specific emotion section.

### [Supplementary Note 6]

The device according to any one of supplementary notes 1 to 5, further including an information acquisition unit that acquires information related to a plurality of individual emotion sections representing a plurality of specific emotional states detected from voice data of the target conversation with respect to each of the plurality of conversation participants, wherein the transition detection unit detects, with respect to each of the plurality of conversation participants, the plurality of predetermined transition patterns on a basis of the information related to the plurality of individual emotion sections acquired by the information acquisition unit, together with information indicating a temporal position in the target conversation.

### [Supplementary Note 7]

The device according to any one of supplementary notes 1 to 6,

wherein the transition detection unit detects a transition pattern from a normal state to a dissatisfied state and a transition pattern from the dissatisfied state to the normal state or a satisfied state on a part of a first conversation participant as the plurality of predetermined transition patterns, and a transition pattern from a normal state to apology and a transition pattern from the apology to the normal state or a satisfied state on a part of a second conversation participant as the plurality of predetermined transition patterns,

wherein the identification unit identifies, as the start point combination, a combination of the transition pattern of the first conversation participant from the normal state to the dissatisfied state and the transition pattern of the second conversation participant from the normal state to the apology, and identifies, as the end point combination, a combination of the transition pattern of the first conversation participant from the dissatisfied state to the normal state or the satisfied state and the transition pattern of the second conversation participant from the apology to the normal state or the satisfied state, and

wherein the section determination unit determines a section representing dissatisfaction of the first conversation participant as the specific emotion section.

### [Supplementary Note 8]

The device according to any one of supplementary notes 1 to 7, further including

a target determination unit that determines a predetermined time range defined about a reference time set in the specific emotion section, as cause analysis section representing the specific emotion that has arisen in the participant of the target conversation.

### [Supplementary Note 9]

The device according to any one of supplementary notes 1 to 8, further including a drawing data generation unit that generates drawing data in which (i) a plurality of first drawing elements representing the individual emotion sections that each represent the specific emotional state included in the plurality of predetermined transition patterns of the first conversation participant, (ii) a plurality of second drawing elements representing the individual emotion sections that each represent the specific emotional state included in the plurality of predetermined transition patterns of the second conversation participant, and (iii) a third drawing element representing the cause analysis section determined by the target determination unit, are aligned in a chronological order in the target conversation.

### [Supplementary Note 10]

A conversation analysis method performed by at least one computer, the method including:

detecting a plurality of predetermined transition patterns of an emotional state on a basis of data related to a voice in a target conversation, with respect to each of a plurality of conversation participants;

identifying a start point combination and an end point combination on a basis of the plurality of predetermined transition patterns detected, the start point combination and the end point combination each being a predetermined combination of the predetermined transition patterns of the plurality of conversation participants that satisfy a predetermined positional condition; and

determining a start time and an end time of a specific emotion section representing a specific emotion of the participant of the target conversation, on a basis of a temporal position of the start point combination and the end point combination identified by the identification unit in the target conversation.

### [Supplementary Note 11]

The method according to claim 10, further including, determining a plurality of possible start times and a plurality of possible end times on a basis of the temporal position of the start point combination and the end point combination identified in the target conversation; and excluding either or both of the plurality of possible start times other than a leading possible start time temporally aligned without the possible end time being interposed, and the plurality of possible end times other than a trailing possible end time temporally aligned without the possible start time being interposed, wherein the determining the start time and the end time of the specific emotion section includes determining a remaining possible start time and a remaining possible end time as the start time and the end time.

### [Supplementary Note 12]

The method according to claim 10 or 11, further including: determining the plurality of possible start times and the plurality of possible end times on a basis of the temporal position of the start point combination and the end point combination identified in the target conversation; and

excluding, out of the possible start times and the possible end times alternately aligned temporally, a second possible start time located within a predetermined time or within a predetermined number of utterance sections after the leading possible start time, and the possible start times and the possible end times located between the leading possible start time and the second possible start time,

wherein the determining the start time and the end time of the specific emotion section includes determining the remaining possible start time and the remaining possible end time as the start time and the end time.

### [Supplementary Note 13]

The method according to any one of claims 10 to 12, further including:

determining the plurality of possible start times and the plurality of possible end times on a basis of the temporal position of the start point combination and the end point combination identified in the target conversation;

calculating, with respect to each of pairs of the possible start time and the possible end time, density of either or both of other possible start times and other possible end times in a time range defined by a corresponding pair; and

determining a credibility score of each of the pairs according to the density calculated,

wherein the determining the start time and the end time of the specific emotion section includes determining the start time and the end time out of the possible start times and the possible end times, according to the determined credibility score.

### [Supplementary Note 14]

The method according to any one of claims 10 to 13, further including:

determining the plurality of possible start times and the plurality of possible end times on a basis of the temporal position of the start point combination and the end point combination identified in the target conversation;

calculating, with respect to the specific emotion section, density of either or both of a determined possible start times and a determined possible end times and located in the specific emotion section; and

determining the credibility score based on the calculated density as credibility score of the specific emotion section.

### [Supplementary Note 15]

The method according to any one of supplementary notes 10 to 14, further including acquiring information related to a plurality of individual emotion sections representing a plurality of specific emotional states detected from the voice data of the target conversation with respect to each of the plurality of conversation participants,

in which the detecting the predetermined transition pattern includes detecting, with respect to each of the plurality of conversation participants, the plurality of predetermined transition patterns on a basis of the acquired information related to the plurality of individual emotion sections, together with information indicating temporal positions in the target conversation.

### [Supplementary Note 16]

The method according to any one of supplementary notes 10 to 15, in which the detecting the predetermined transition pattern includes detecting (i) a transition pattern from a normal state to a dissatisfied state and a transition pattern from the dissatisfied state to the normal state or a satisfied state on a part of a first conversation participant as the plurality of predetermined transition patterns, and (ii) a transition pattern from a normal state to apology and a transition pattern from the apology to the normal state or a satisfied state on a part of a second conversation participant as the plurality of predetermined transition patterns,

the identifying the start point combination and the end point combination includes (i) identifying, as the start point combination, a combination of the transition pattern of the first conversation participant from the normal state to the dissatisfied state and the transition pattern of the second conversation participant from the normal state to the apology, and (ii) identifying, as the end point combination, a combination of the transition pattern of the first conversation participant from the dissatisfied state to the normal state or the satisfied state and the transition pattern of the second conversation participant from the apology to the normal state or the satisfied state, and

the determining the specific emotion section includes determining a section representing dissatisfaction of the first conversation participant as the specific emotion section.

### [Supplementary Note 17]

The method according to any one of supplementary notes 10 to 16, further including determining a predetermined time range defined about a reference time set in the specific emotion section, as cause analysis section representing the specific emotion that has arisen in the participant of the target conversation.

### [Supplementary Note 18]

The method according to any one of supplementary notes 10 to 17, further including, generating drawing data in which (i) a plurality of first drawing elements representing the individual emotion sections that each represent the specific emotional state included in the plurality of predetermined transition patterns of the first conversation participant, (ii) a plurality of second drawing elements representing the individual emotion sections that each represent the specific emotional state included in the plurality of predetermined transition patterns of the second conversation participant, and (iii) a third drawing element representing the cause analysis section determined are aligned in a chronological order in the target conversation.

### [Supplementary Note 19]

A program that causes at least one computer to execute the conversation analysis method according to any one of supplementary notes 10 to 18.

### [Supplementary Note 20]

A computer-readable recording medium stores the program according to supplementary note 19.

This application claims priority based on Japanese Patent Application No. 2012-240763 filed on Oct. 31, 2012, the content of which is incorporated hereinto by reference in its entirety.

What is claimed is:

1. A conversation analysis device comprising:
a transition detection unit that detects a plurality of predetermined transition patterns of an emotional state on a basis of data related to a voice in a target conversation, with respect to each of a plurality of conversation participants;
an identification unit that identifies a start point combination and an end point combination on a basis of the plurality of predetermined transition patterns detected by the transition detection unit, the start point combination and the end point combination each being a predetermined combination of the predetermined transition patterns of the plurality of conversation participants that satisfy a predetermined positional condition; and
a section determination unit that determines a start time and an end time on a basis of a temporal position of the start point combination and the end point combination identified by the identification unit in the target conversation, to thereby determine a specific emotion section defined by the start time and the end time and representing a specific emotion of the participant of the target conversation.

2. The device according to claim 1,
wherein the section determination unit determines a plurality of possible start times and a plurality of possible end times on a basis of the temporal position of the start point combination and the end point combination identified by the identification unit in the target conversation, excludes either or both of the plurality of possible start times other than a leading possible start time temporally aligned without the possible end time being interposed, and the plurality of possible end times other than a trailing possible end time temporally aligned without the possible start time being interposed, and determines a remaining possible start time and a remaining possible end time as the start time and the end time.

3. The device according to claim 1,
wherein the section determination unit determines the plurality of possible start times and the plurality of possible end times on a basis of the temporal position of the start point combination and the end point combination identified by the identification unit in the target conversation,
wherein the section determination unit excludes, out of the possible start times and the possible end times alternately aligned temporally, a second possible start time located within a predetermined time or within a predetermined number of utterance sections after the leading possible start time, and the possible start times and the possible end times located between the leading possible start time and the second possible start time, and
wherein the section determination unit determines the remaining possible start time and the remaining possible end time as the start time and the end time.

4. The device according to claim 1, further comprising a credibility determination unit that calculates, with respect to each of pairs of the possible start time and the possible end time determined by the section determination unit, density of either or both of other possible start times and other possible end times in a time range defined by a corresponding pair, and determines a credibility score according to the density calculated,
wherein the section determination unit determines the plurality of possible start times and the plurality of possible end times on a basis of the temporal position of the start point combination and the end point combination identified by the identification unit in the target conversation, and determines the start time and the end time out of the possible start times and the possible end times, according to the credibility score determined by the credibility determination unit.

5. The device according to claim 1, further comprising the credibility determination unit that calculates, with respect to the specific emotion section determined by the section determination unit, density of either or both of the possible start times and the possible end times determined by the section determination unit and located in the specific emotion section, and determines the credibility score according to the calculated density,
wherein the section determination unit determines the plurality of possible start times and the plurality of possible end times on a basis of the temporal position of the start point combination and the end point combination identified by the identification unit in the target conversation, and determines the credibility score determined by the credibility determination unit as credibility score of the specific emotion section.

6. The device according to claim 1, further comprising:
an information acquisition unit that acquires information related to a plurality of individual emotion sections representing a plurality of specific emotional states detected from voice data of the target conversation with respect to each of the plurality of conversation participants,
wherein the transition detection unit detects, with respect to each of the plurality of conversation participants, the plurality of predetermined transition patterns on a basis of the information related to the plurality of individual emotion sections acquired by the information acquisition unit, together with information indicating a temporal position in the target conversation.

7. The device according to claim 1,
wherein the transition detection unit detects a transition pattern from a normal state to a dissatisfied state and a transition pattern from the dissatisfied state to the normal state or a satisfied state on a part of a first conversation participant as the plurality of predetermined transition patterns, and a transition pattern from a normal state to apology and a transition pattern from the apology to the normal state or a satisfied state on a part of a second conversation participant as the plurality of predetermined transition patterns,
wherein the identification unit identifies, as the start point combination, a combination of the transition pattern of the first conversation participant from the normal state to the dissatisfied state and the transition pattern of the second conversation participant from the normal state to the apology, and identifies, as the end point combination, a combination of the transition pattern of the first conversation participant from the dissatisfied state to the normal state or the satisfied state and the transition pattern of the second conversation participant from the apology to the normal state or the satisfied state, and
wherein the section determination unit determines a section representing dissatisfaction of the first conversation participant as the specific emotion section.

8. The device according to claim 1, further comprising
a target determination unit that determines a predetermined time range defined about a reference time set in the specific emotion section, as cause analysis section representing the specific emotion that has arisen in the participant of the target conversation.

9. The device according to claim 1, further comprising:
a drawing data generation unit that generates drawing data in which (i) a plurality of first drawing elements representing the individual emotion sections that each represent the specific emotional state included in the plurality of predetermined transition patterns of the first conversation participant, (ii) a plurality of second drawing elements representing the individual emotion sections that each represent the specific emotional state included in the plurality of predetermined transition patterns of the second conversation participant, and (iii) a third drawing element representing the cause analysis section determined by the target determination unit, are aligned in a chronological order in the target conversation.

10. A conversation analysis method performed by at least one computer, the method comprising:
detecting a plurality of predetermined transition patterns of an emotional state on a basis of data related to a voice in a target conversation, with respect to each of a plurality of conversation participants;
identifying a start point combination and an end point combination on a basis of the plurality of predetermined transition patterns detected, the start point combination and the end point combination each being a predetermined combination of the predetermined transition patterns of the plurality of conversation participants that satisfy a predetermined positional condition; and
determining a start time and an end time of a specific emotion section representing a specific emotion of the participant of the target conversation, on a basis of a temporal position of the start point combination and the end point combination identified in the target conversation.

11. The method according to claim 10, further comprising:
determining a plurality of possible start times and a plurality of possible end times on a basis of the temporal position of the start point combination and the end point combination identified in the target conversation; and
excluding either or both of the plurality of possible start times other than a leading possible start time temporally aligned without the possible end time being interposed, and the plurality of possible end times other than a trailing possible end time temporally aligned without the possible start time being interposed,
wherein the determining the start time and the end time of the specific emotion section includes determining a remaining possible start time and a remaining possible end time as the start time and the end time.

12. The method according to claim 10, further comprising:
determining the plurality of possible start times and the plurality of possible end times on a basis of the temporal position of the start point combination and the end point combination identified in the target conversation; and
excluding, out of the possible start times and the possible end times alternately aligned temporally, a second possible start time located within a predetermined time or within a predetermined number of utterance sections after the leading possible start time, and the possible start times and the possible end times located between the leading possible start time and the second possible start time,
wherein the determining the start time and the end time of the specific emotion section includes determining the remaining possible start time and the remaining possible end time as the start time and the end time.

13. The method according to claim 10, further comprising:
determining the plurality of possible start times and the plurality of possible end times on a basis of the temporal position of the start point combination and the end point combination identified in the target conversation;
calculating, with respect to each of pairs of the possible start time and the possible end time, density of either or both of other possible start times and other possible end times in a time range defined by a corresponding pair; and
determining a credibility score of each of the pairs according to the density calculated,
wherein the determining the start time and the end time of the specific emotion section includes determining the start time and the end time out of the possible start times and the possible end times, according to the determined credibility score.

14. The method according to claim 10, further comprising:
determining the plurality of possible start times and the plurality of possible end times on a basis of the temporal position of the start point combination and the end point combination identified in the target conversation;
calculating, with respect to the specific emotion section, density of either or both of the possible start times and the possible end times determined and located in the specific emotion section; and
determining the credibility score based on the calculated density as credibility score of the specific emotion section.

15. A non-transitory computer readable medium storing a program that causes at least one computer to execute the conversation analysis method according to claim 10.

16. A conversation analysis device comprising:
a transition detection means for detecting a plurality of predetermined transition patterns of an emotional state on a basis of data related to a voice in a target conversation, with respect to each of a plurality of conversation participants;
an identification means for identifying a start point combination and an end point combination on a basis of the plurality of predetermined transition patterns detected by the transition detection means, the start point combination and the end point combination each being a predetermined combination of the predetermined transition patterns of the plurality of conversation participants that satisfy a predetermined positional condition; and
a section determination means for determining a start time and an end time on a basis of a temporal position of the start point combination and the end point combination identified by the identification means in the target conversation, to thereby determine a specific emotion section defined by the start time and the end time and representing a specific emotion of the participant of the target conversation.
